(19) United States
(12) Patent Application Publication
(10) Pub. No.: US 2008/0061100 A1
(43) Pub. Date: Mar. 13, 2008

(54) Device And Method For Fracture Splitting Of Workpieces

(75) Inventors: Stefan Hansch, Aalen (DE); Horst Wisniewski, Aalen (DE)

Correspondence Address: WOLF GREENFIELD & SACKS, P.C., 600 ATLANTIC AVENUE, BOSTON, MA, 02210-2206, US

(73) Assignee: Alfing Kessler Sondermaschinen GmbH, Aalen (DE)

(21) Appl. No.: 11/629,146

(22) PCT Filed: May 19, 2005
(86) PCT No.: PCT/EP05/05443

§ 371 Date: Aug. 9, 2007

(30) Foreign Application Priority Data
Jun. 11, 2004 (DE) 10 2004 028 316.8

(51) Int. Cl. B23D 31/00

(52) U.S. Cl. 225/96; 225/103

(57) ABSTRACT

The invention relates to a device for fracture splitting of an annular section (12) of a workpiece, with a housing (34) for mounting the workpiece (10), during the machining, a laser device (30), for the formation of two diametrically opposed nicks in an inner circumferential surface (16) of the annular section (12) by fusion of the material using laser energy and a fracture splitting device (32), for the fracture splitting of the annular section (12) of the workpiece (10) into two pieces along a fracturing plane (5) given by the nicks, characterised in that the laser device (30) and the fracture splitting device (32) form a single machining station and are embodied such that the formation of the nicks and fracture splitting of the workpiece (10) are carried out from opposing sides of the workpiece (10).

### FIELD OF THE INVENTION

The present invention relates to devices and methods for the fracture splitting of an annular section of a workpiece.

### PRIOR ART

The fracture splitting of workpieces takes place for example during the production of connecting rods or crank cases for combustion engines. In this regard, two diametrically opposed nicks are formed in the inner circumferential surface of a mounting section defining a fracturing plane along which the workpiece can be split into two portions. The formation of the nicks, also known as notches, is performed in a broaching station or laser station.

The fracture splitting as such is performed in a spatially separate fracture splitting station, in which an expanding segment—for example an expanding mandrel or a pair of expanding jaws—is introduced into the section to be split so that the workpiece is split by the expansion forces and the stress concentration in the notch apexes along the prespecified fracturing plane is separated.

Following the fracture splitting process (cracking) and a few intermediate processing states, the two portions can be joined together again. The irregular, relatively large fracture surface formed during the fracture splitting facilitates defined joining of the workpiece whereby the intermeshing of the fracture surfaces prevents the lateral displacement of the workpiece portions.

The nicks defining the fracturing plane can be formed, for example, by means of a broaching process. In this regard, the shape of the broaching tool results in V-shaped nicks with a relatively large nick width.

Known from U.S. Pat. No. 5,208,979 is a method in which a laser is used to produce such nicks. Here, in addition to its axial feed, the laser beam running obliquely to the surface to be notched is swung obliquely to the nick formed. The nick formed is also V-shaped.

In a further development of this method, nicks are also produced according to EP 0 808 228 B1 in the inner circumferential surface of a connecting rod bearing section by means of a laser. However, here the laser is controlled so that a plurality of nick sections spaced apart from each other and lying behind each other in a line are formed. The angle between the axis of the nick sections and the connecting rod axis is preferably between 30° and 60°.

Finally, WO 97/22430 describes a method for forming a cracking site for fracture separation of a connecting rod in which the cracking site is formed along one side of a fracture separation plane by recesses having webs and starting from the component surface. In a ductile metal component at least the webs are embrittled or fully hardened at least in sections for producing first starting cracks for triggering a fracture.

In all these known methods, the laser is moved in a laser station, generally from above, toward the workpiece or alternatively the workpiece is guided upward to the stationary laser in order to produce the nicks or cracking sites. Then, the workpiece is conveyed to a separate fracture splitting station and fracture split there, whereby the expanding element used for the fracture splitting is also introduced into the annular section of workpiece generally from above.

### DESCRIPTION OF THE INVENTION

It is the object of the present invention, to provide a device and a method for fracture splitting an annular section of a workpiece of the type described in the introduction with which the sequence of operations for the fracture splitting of the workpiece is simplified. This object is achieved on the one hand by a device according to claim 1 and a method according to claim 11.

Accordingly, the laser device and the fracture splitting device may be advanced to the workpiece from opposing sides of the workpiece.

According to the invention, the laser device and the fracture splitting device are integrated in a single machining station in which they can access the workpiece from opposing sides. In this station, firstly the laser device can produce the nicks defining the fracturing plane from one side of the workpiece and then the workpiece can be fracture split immediately from the other side by means of the fracture splitting device. After the production of the nicks, the workpiece no longer has to be conveyed from a laser device to a fracture splitting station. This simplifies the sequence of operations noticeably and also reduces the procurement costs for the device, since instead of two separate stations—the laser station and the fracture splitting station—it is only necessary to provide a single machining station.

Preferred embodiments of the device according to the invention and of the method according to the invention are described in the related dependent claims.

If the workpiece is conveyed in a conveying device through the machining station, the laser device and the fracture splitting device are preferably positioned at a distance from each other in a direction extending at right angles to this direction of conveyance. The laser device and the fracture splitting device can, for example, be disposed at a vertical or horizontal distance in relation to each other, that is, one on top of the other or next to each other.

Respective slides can be used to mount the laser device, the fracture splitting device and/or the housing movably for the machining of the workpiece. In this way, to produce the nicks, either the laser device or the housing is advanced. In the same way, for the fracture splitting, either the fracture splitting device or the housing with the workpiece can be suitably advanced.

To produce the nicks in the inner circumferential surface of the annular section of the workpiece, the laser device can generate laser beams in any angle between 0° and 90° to the centre axis of this annular section, for example parallel to this axis or parallel to the circumferential surface or at right angles thereto.

On the other hand, the object stated above is achieved by a device for producing nicks in a circumferential surface of an annular section of a workpiece according to claim 10 and a method for producing nicks in a circumferential surface of an annular section of a workpiece by means of laser energy according to claim 15.

Accordingly, to produce the nicks in the circumferential surface of the annular section, at least one laser beam is directed substantially parallel to the circumferential surface.

In this regard, the nicks produced in the circumferential surface of the annular section of the workpiece can have a width of up to approximately 0.5 mm and a depth of up to approximately 1.0 mm.

Previously, it was thought to be impossible to align the laser beam parallel to the surface to be notched due to the relatively short focal length of the laser beam compared to the length of the surface to be notched. The inventor's investigations surprisingly found that this belief was incorrect. Fracture splitting tests with nicks notched in this way resulted in high-quality workpieces with a low breaking force.

### BRIEF DESCRIPTION OF THE DRAWINGS

In the attached drawings

FIG. 1 shows a connecting rod which can be fracture split by a device according to the invention,

FIG. 2 shows a connecting rod after the fracture splitting,

FIG. 3 shows a device according to the invention,

FIG. 4 shows another device according to the invention,

FIG. 5 shows an alternative device according to the invention for the fracture splitting of workpieces,

FIG. 6 shows a top view of laser optics that can be used in a device according to the invention, and

FIG. 7 shows a sectional view of the laser optics in FIG. 6.

### PREFERRED EMBODIMENTS OF THE INVENTION

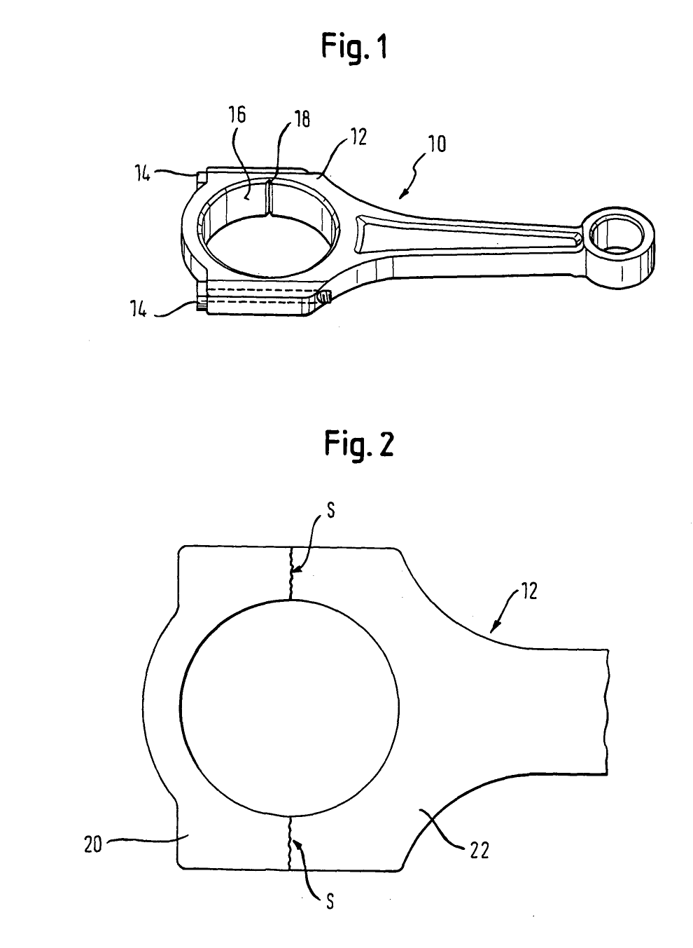

FIG. 1 shows a connecting rod 10, with an annular mounting section 12 that can be fracture split by means of a device according to the invention.

As FIG. 1 shows, two diametrically opposed nicks 18 have already been produced on the inner circumferential surface 16 of the mounting section 12 by means of the laser device in a device according to the invention. These nicks 18 define a fracturing plane along which the mounting section 12 can be fracture split by means of the fracture splitting device of a device according to the invention.

FIG. 2 is a schematic diagram of the mounting section 12 of the connecting rod after the fracture splitting: it is split along the fracturing plane S into two portions 20, 22.

After the fracture splitting, the annular mounting section 12 can be attached to a crankshaft (not shown) by re-connecting the two portions 20, 22 produced during the fracture splitting to each other by means of two connecting rod bolts 14 (FIG. 1).

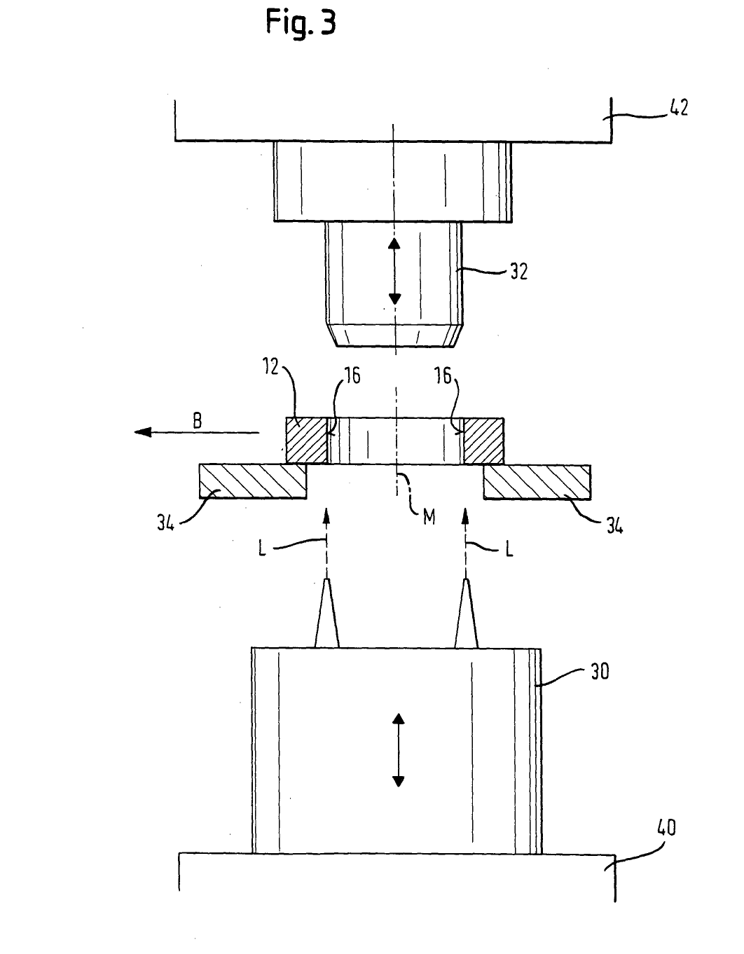

A first embodiment of the device according to the invention is shown in FIG. 3. A laser device 30 for producing the nicks and a fracture splitting device 32 for fracture splitting of the workpiece are integrated in a single machining station.

A housing 34 is used to mount the workpiece, of which the annular section 12 is shown here in section, during the machining.

The diametrically opposed nicks in the inner circumferential surface 16 of the section 12 of the workpiece are produced by means of a vertically moveable laser device 30 provided underneath the housing 34. For this, the laser device 30 is mounted on a slide 40 which in turn may be moved upward and downward relative to a stationary housing part. This vertical upward and downward movement is performed at right angles to a direction of conveyance B in which the workpiece is conveyed into and out of the machining station.

In the embodiment shown, the axes of the laser beams L for producing the nicks extend parallel to the centre axis M of the annular section 12, and also parallel to the inner circumferential surface 16. During the production of the nicks in preparation for the fracture splitting of the annular section of the workpiece, the laser beam is therefore directed parallel to the surface to be notched. This also has the substantial advantage that the laser beam emitted by the laser device can strike the workpiece directly and does not need to be additionally deflected.

After the production of the nicks by means of the laser device 30, a fracture splitting device 32 is used, which is disposed above the housing 34 and can also be moved vertically, that is, at right angles to the direction of conveyance B of the workpiece in the direction of the housing 34. For this, the fracture splitting device 32 is mounted on a slide 42 which in turn may be moved upward and downward relative to a stationary housing part. As in conventional devices, the fracture splitting is performed using an expanding element, such as for example an expanding mandrel or a pair of expanding jaws.

Then the workpiece can be conveyed out of the machining station in the direction indicated by the arrow B and then machined.

As an alternative to the laser device used according to FIG. 3, it is also possible to use any other laser device that is known per se. It is also possible to use a laser device which only generates a single laser beam which by means of a suitable movement of the laser device or the workpiece can be used to produce both nicks. The laser devices which are known per se with crisscrossing beams can also be used.

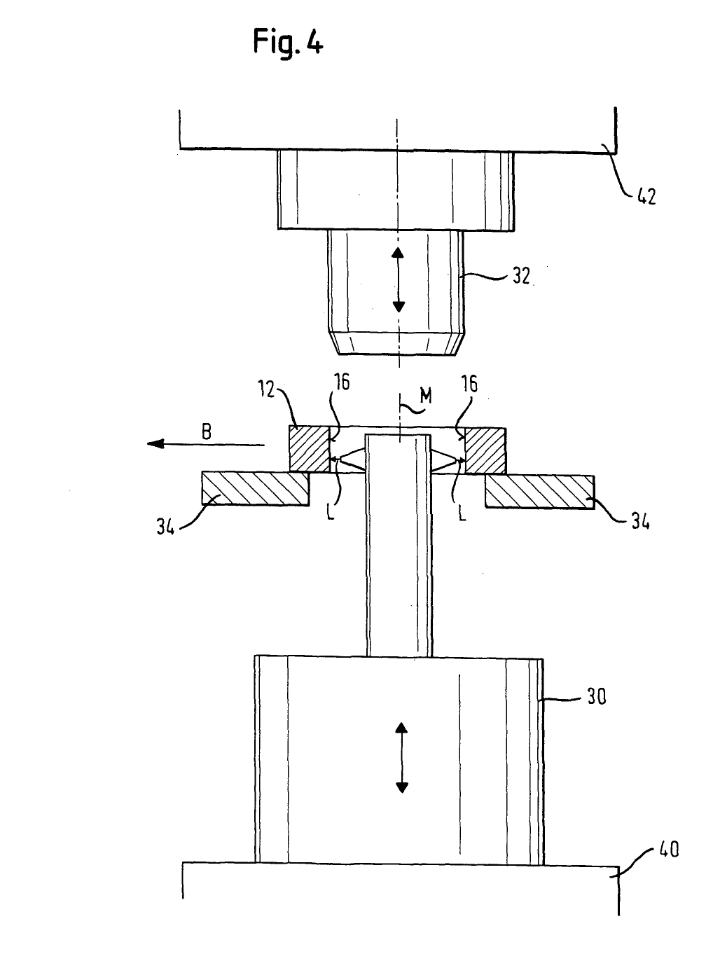

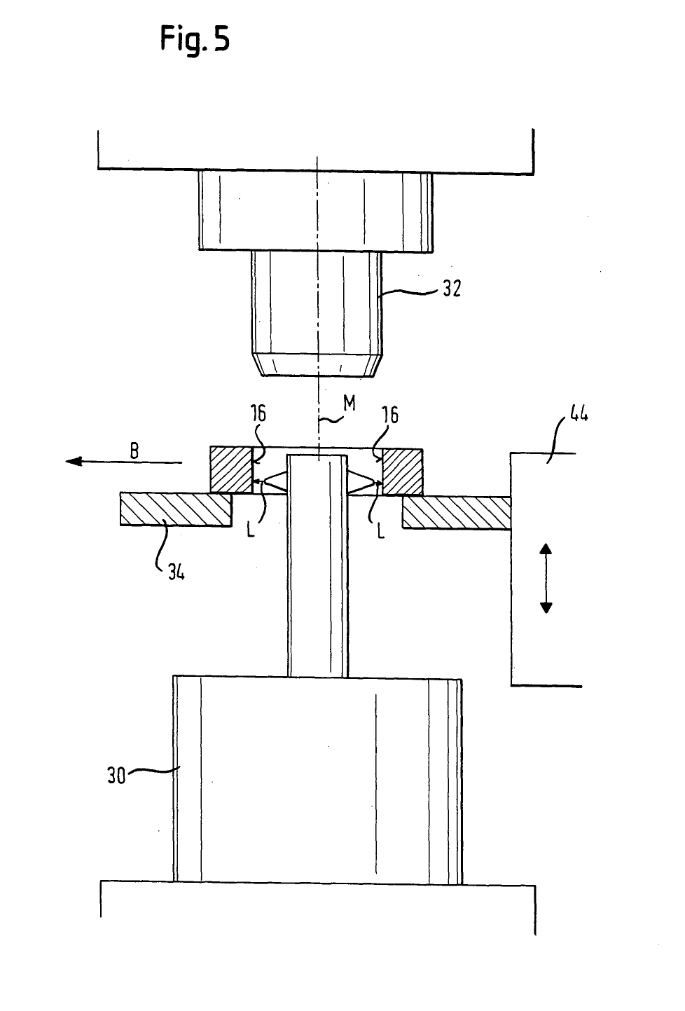

In this regard, although the laser beams L can in principle form any angle between 0° and 90° with the centre axis of the workpiece, angles of 0° and 90° have correspondingly a particularly low energy usage and a particularly well defined crack initiation with a low fracture force. FIG. 4 shows, for example, a case in which the laser device 30 is embodied so that the axes of the laser beams L extend at right angles to the centre axis M of the annular section 12 and to the circumferential surface 16. Otherwise, the device shown in FIG. 4 is the same as that shown in FIG. 3.

Instead of moving the laser device 30 and the fracture splitting device 32 by means of the slides 40, 42 toward and away from the workpiece on the housing 34, the housing 34 can also be displaceable. FIG. 5 shows a variant of this kind. Here, the housing 34 is in turn attached to a vertically displaceable slide 44, while the laser device 30 and the fracture splitting device 32 are stationary. The housing 34 again moves at right angles to the direction of conveyance B of the workpiece.

In the embodiments shown in FIGS. 3 to 5, the laser device 30 and the fracture splitting device 32 are disposed one on top of the other and the workpiece is moved horizontally through the machining station (direction B). However, it is just as conceivable to dispose the laser device 30 and the fracture splitting device 32 next to each other, that is, at a horizontal distance from each other.

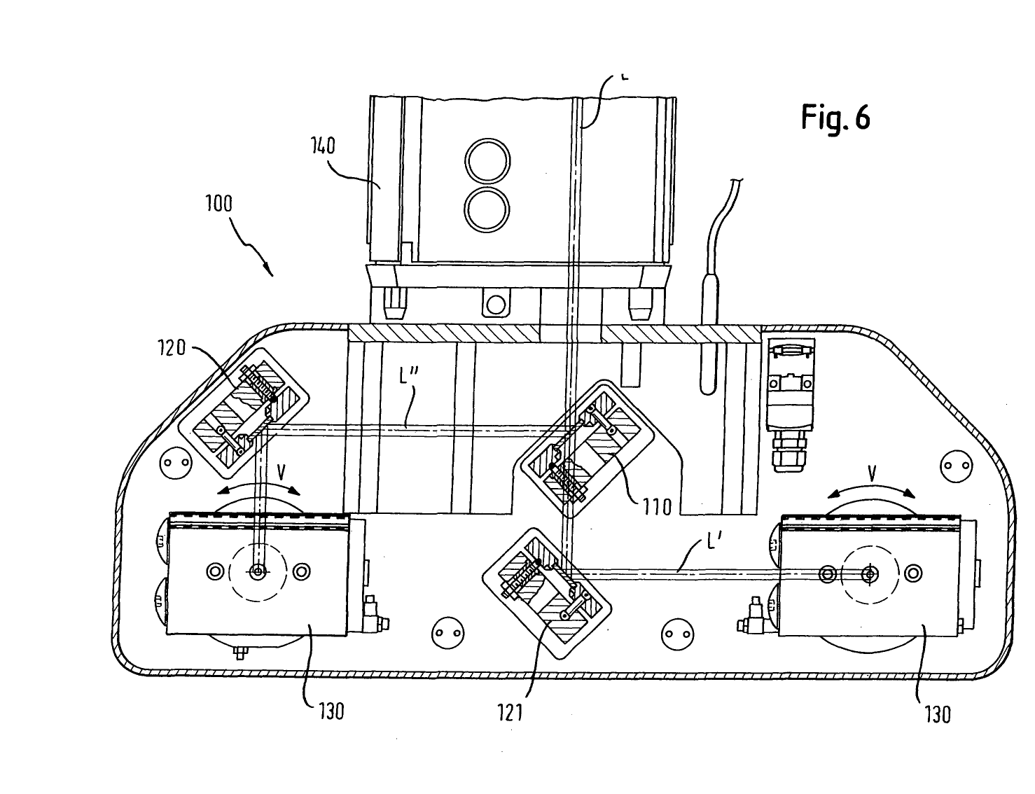

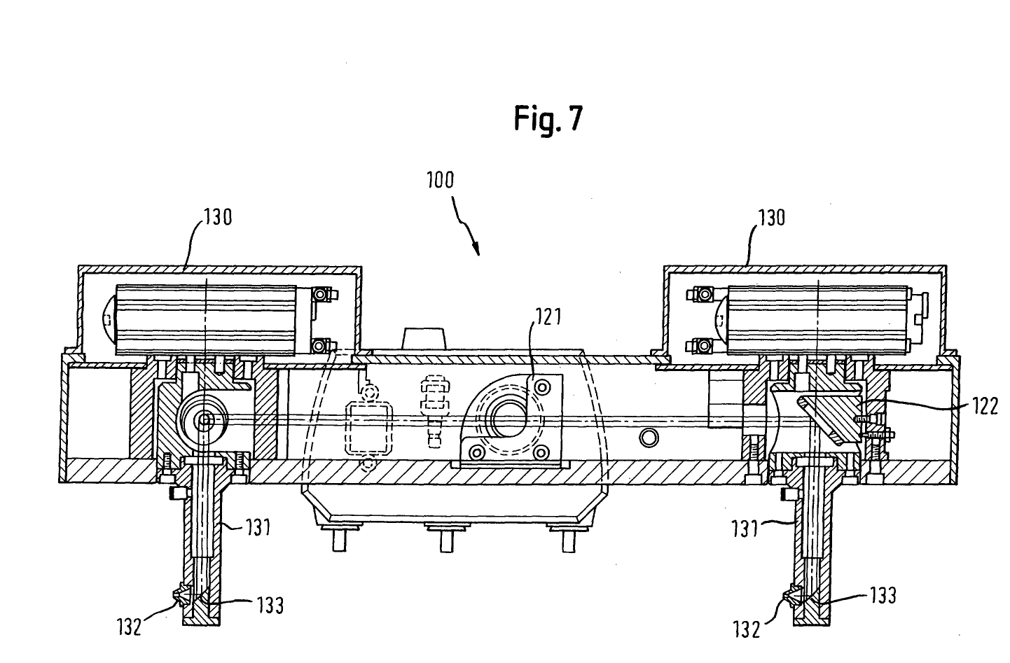

FIGS. 6 and 7 show a top view or a sectional view of laser optics 100 such as could be used in a laser device 30 according to the invention.

FIG. 6 first shows the beam path of the laser beam L through these laser optics 100: starting from the laser 140, the laser beam L first passes through an adjustable 50%/50% beam splitter 110, which divides the laser beam L into two partial beams L′, L″. These two partial beams L′, L″ may be used to produce two nicks simultaneously in a workpiece to be fracture split. For this, the partial beams L′, L″ are deflected by means of adjustable beam deflectors 120, 121 and sent to two swivel units 130.

As is evident from the section view in FIG. 7, these swivel units 130 each comprise a machining unit 131 that may be swivelled about 180°; the swivel units are each identified in FIG. 6 by means of an arrow V. The partial beams L′, L″ are diverted into the corresponding machining units 131 by means of another adjustable beam diverter 122. Through the machining units 131, the laser beams L′, L″ are then guided to two laser heads 132 disposed at the end of the machining units 131 and from which the laser beams L′, L″ emerge to produce nicks in a workpiece.

Configuring the beam deflector 133 at the end of the machining unit 131 enables the laser beam to be guided out of the laser heads 132 cylindrically or ovally in the transverse or longitudinal direction by a special shape of the reflecting surface.

1. Device for fracture splitting of an annular section of a workpiece with
a housing for mounting the workpiece during the machining,
a laser device for the formation of nicks in a circumferential surface of the annular sections, and
a fracture splitting device for the fracture splitting of the annular section of the workpiece along a fracturing plane defined by the nicks, whereby
the laser device and the fracture splitting device form a single machining station and with them, the formation of the nicks and the fracture splitting of the workpiece may be carried out from opposing sides of the workpiece, wherein the laser device and the housing for the workpiece are disposed relative to each other in such a way that a laser beam generated by the laser device extends substantially in parallel to the circumferential surface of the workpiece.

2. Device according to claim 1, in which the workpiece is conveyed in one direction of conveyance through the machining station, and the laser device and the fracture splitting device are positioned at a distance from each other in a direction extending at right angles to this direction of conveyance.

3. Device according to claim 1, in which the laser device and the fracture splitting device are disposed at a vertical or horizontal distance from each other.

4. Device according to claim 1, which also comprises a slide by means of which the fracture splitting device may be moved toward and away from the housing.

5. Device according to claim 1, which also comprises a slide by means of which the housing can be moved toward and away from the laser device and/or the fracture splitting device.

6.-7. (canceled)

8. Device for producing nicks in a circumferential surface of an annular section of a workpiece, with
a housing for mounting the workpiece during the machining and
a laser device for the formation of nicks in the circumferential surface of the annular section, wherein
the laser device and the housing for the workpiece are disposed relative to each other in such a way that a laser beam generated by the laser device extends substantially parallel to the circumferential surface of the workpiece.

9. Device according to claim 8, which also comprises a slide by means of which the laser device may be moved toward and away from the housing.

10. Device according to claim 8, in which the laser device generates at least one laser beam substantially parallel to the centre axis of the annular section of the workpiece.

11. Method for fracture splitting of an annular section of a workpiece in which nicks are first formed by means of laser energy in a circumferential surface of this annular section and define the course of a fracturing plane and in which the annular section of the workpiece is fracture split in a subsequent fracture splitting process along this fracturing plane, whereby
the formation of the nicks and the fracture splitting of the workpiece are carried out in a single machining station from opposing sides of the workpiece in which for the formation of the nicks in the circumferential surface of the annular section, at least one laser beam is directed substantially parallel to the circumferential surface.

12. Method according to claim 11, in which for the formation of the nicks in the circumferential surface of the annular section of the workpiece, at least one laser beam is directed substantially parallel to the centre axis of this annular section.

13.-14. (canceled)

15. Method for the generation of nicks in a circumferential surface of an annular section of a workpiece by means of laser energy, wherein
for the formation of the nicks in the circumferential surface of the annular section, at least one laser beam is directed substantially parallel to the circumferential surface.

16. Method according to claim 15, in which the nicks produced in the inner circumferential surface of the annular section of the workpiece have a width of up to approximately 0.5 mm and a depth of up to approximately 1.0 mm.

17. Device for fracture splitting an annular section of a workpiece, with a device for producing nicks in a circumferential surface of the annular section of the workpiece according to claim 8 and a fracture splitting device for the fracture splitting of the annular section of the workpiece along a fracturing plane defined by the nicks.
